(19) United States
(12) Patent Application Publication
(10) Pub. No.: US 2007/0268119 A1
(43) Pub. Date: Nov. 22, 2007

(54) Child abandonment avoidance system for automobiles

(76) Inventors: Daryl Cram, Queen Creek, AZ (US); Tracy Cram, Queen Creek, AZ (US)

Correspondence Address: Gene Ayres;Suite 101, 1430 W. Broadway Rd., Tempe, AZ, 85282, US

(21) Appl. No.: 11/437,194

(22) Filed: May 18, 2006

(51) Int. Cl. B60Q 1/00; G08B 23/00

(52) U.S. Cl. 340/457; 340/573.1

(57) ABSTRACT

A child safety system is described which senses when a child is left alone in an automobile and alerting others. One implementation includes a weight sensor pad for sensing a child's weight applied to an infant car seat, a transmitter to transmit, to an alarm device, an alert signal when a child is in the seat, and a driver door switch. The alarm device generates an alarm signal (e.g., a loud siren noise) if a baby is in the seat after the door switch indicates the driver has left the car.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to automobile safety equipment. More particularly, the invention relates to an in-automobile child sensor and alarm.

### BACKGROUND OF THE INVENTION

Every year, children are injured or die due to being left unattended inside of parked vehicles, and in some instances, these children are left only for a few minutes. More alarming, the number of deaths due to this have been increasing each year. It certainly is not the intention of the vehicle operators to subject these children to such dangers. In many cases, the vehicle operators just need simple reminding of the presence of the children.

If the outdoor temperature is 90° F., the interior temperature of a parked vehicle can rise to 125° F. in only twenty minutes. After another twenty minutes, the temperature can rise to 150° F., and even if the vehicle's windows are open, the interior temperature will only be 10° F. cooler, which is still a dangerous level. Being exposed to temperatures of 100° F. can be fatal for a small child. Such heat rapidly overwhelms the ability of small children's bodies to regulate their own temperatures. When exposed to such temperatures in the closed environment of an automobile, children's bodies can go into shock and circulation to vital organs will begin to fail, resulting in heat stoke in just a few minutes.

This circumstance can happen even when outdoor temperatures are cool. Even if the outdoor temperature is as low as 60° F., the interior temperature of a vehicle can reach fatal levels for a child in less than twenty minutes. This danger is far more fatal than commonly realized, made evident by the increase in annual occurrences of fatality due to this circumstance. A child's core body temperature can increase three-to-five times faster than an adult's, so even a quick stop at the store can generally be fatal to a young child. Unfortunately, not enough adults are aware of this risk.

Some parents admittedly believe that it is perfectly fine to leave a small child alone in a car, and for first-time parents of ages twenty-four and younger, the belief that this potentially fatal incident is prefectly acceptable is more common than with older parents. The perception of this risk is becoming more well known, and today it is illegal in twelve states to leave a child unattended in a parked vehicle. Unfortunately, these strategic legal efforts have not proven completely effective as children are still routinely left alone inside of parked vehicles.

In view of the foregoing, there is a need for alerting vehicle operators of the presence of a child in the vehicle. There is also a need for a method of reminding the operator of the dangers of leaving a child unattended in a parked vehicle.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1 and 2 show perspective views of an exemplary child sensor device in use with an exemplary child's car seat, in accordance with an embodiment of the present invention. FIG. 1 shows the child's car seat outside of a vehicle, and FIG. 2 shows the child's car seat inside of a vehicle;

FIG. 3 shows a front view of an exemplary alarm device for alerting a vehicle operator to the presence of a child in the vehicle, in accordance with an embodiment of the present invention; and

FIG. 4 shows a perspective view of an exemplary car door with an exemplary alarm device mounted to the door, in accordance with an embodiment of the present invention.

Unless otherwise indicated illustrations in the figures are not necessarily drawn to scale.

### SUMMARY OF THE INVENTION

To achieve the foregoing and other objects and in accordance with the purpose of the invention, a variety of techniques are described for a child safety system for sensing when a child is left alone in an automobile and alerting others.

One embodiment of the present invention includes a weight sensor unit being operable for sensing weight applied to a seat and generating a corresponding weight reading, the seat being located within the automobile and operable for the child to apply his or her weight upon when secured onto the seat, a sensor processing unit, the sensor processing unit being configured to receive the weight reading from the weight sensor and to generate an alert signal based upon the weight sensor reading, an alert signal transmission unit configured to receive the alert signal from the sensor processing unit and transmit the alert signal, an occupant detection unit that is configured to detect and signal that an occupant of the automobile has exited the automobile, an alarm unit, the alarm unit being configured to receive both the transmitted alert signal from the alert transmission unit and the occupant exiting signal, the alarm unit being further configured to generate an alarm signal based on the received signal, and an alarm communication unit, the alarm communication unit being configured to receive the alarm signal from the alarm unit, and communicate the alarm signal to a receiving person or system.

A multiplicity of alternate embodiments of the present invention may be configured by implementing the foregoing in any combination of the following in which: the weight sensor unit is a weight-sensor pad placed onto the surface of the seat where the child sits upon; and/or the weight reading is a binary signal indicating the presence or not of a certain amount of weight on the seat; and/or the weight reading is an analog signal and the sensor processing unit comprises electronics to threshold the analog signal to thereby generate a binary alert signal that indicates the presence or not of a certain amount of weight on the seat; and/or the alert signal transmission unit is a wireless transmitter system comprised of a radio transmitter and a antenna, and in which the alarm unit comprise a corresponding radio receiver configured to properly receive and decode the wirelessly transmitted alert signal; and/or the alert signal transmission unit is a wired transmitter system, and in which the alarm unit comprise a corresponding wired receiver configured to properly receive and decode the transmitted alert signal; and/or the occupant detection unit is a door opening detection switch configured to cooperate with a driver's door of the automobile to detect the opening and closing thereof, the door opening detection switch being operable to generate the signal that indicates that an operator of the automobile has exited the automobile; and/or the door opening detection switch is a magnetically activated switch; and/or the alarm unit only generates an alarm signal if the alert signal is activated while the door opening detection switch indicates the door has been opened and closed; and/or the alarm unit is mounted to the inside of a driver's door of the automobile; and/or the alarm communication unit is a audible speaker system comprised in the alarm unit, and the alarm signal is an audible alarm generated by the audible speaker system.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice verse and masculine as feminine and vice verse, where appropriate, and alternatives embodiments do not necessarily imply that the two are mutually exclusive.

The present invention will now be described in detail with reference to embodiments thereof as illustrated in the accompanying drawings.

One aspect of the present invention is to alert vehicle operators of the presence of a child in a vehicle and ensure that the vehicle operators are always reminded of the dangers of leaving their young ones alone in a parked vehicle. In some embodiments, these alerts and reminders inform parents and other vehicle operators of the harm that may be done to the child in order to prevent this harm, to extend the national awareness of the dangers of leaving small children unattended in parked vehicles, and to help enforce the laws of some states. Another aspect of the present invention is to assist the conscientiousness of vehicle operators regarding the safety of their young passengers, and protect children from the dangers of extended heat and cold when left in parked automobiles.

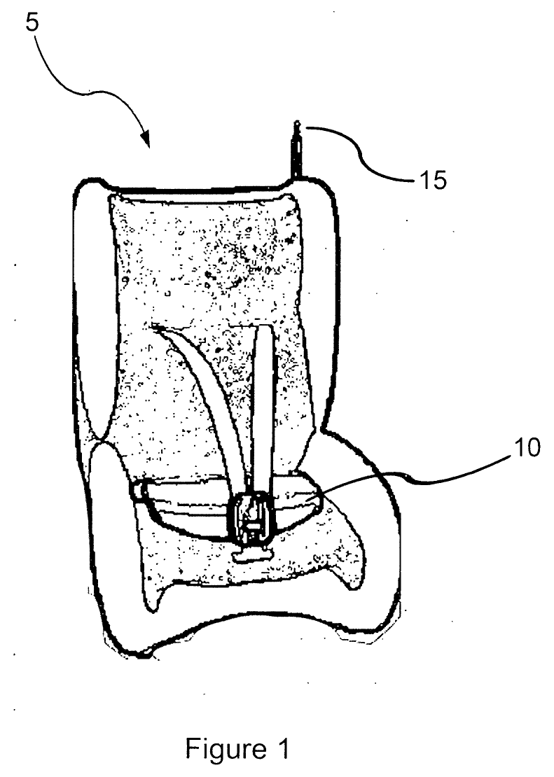

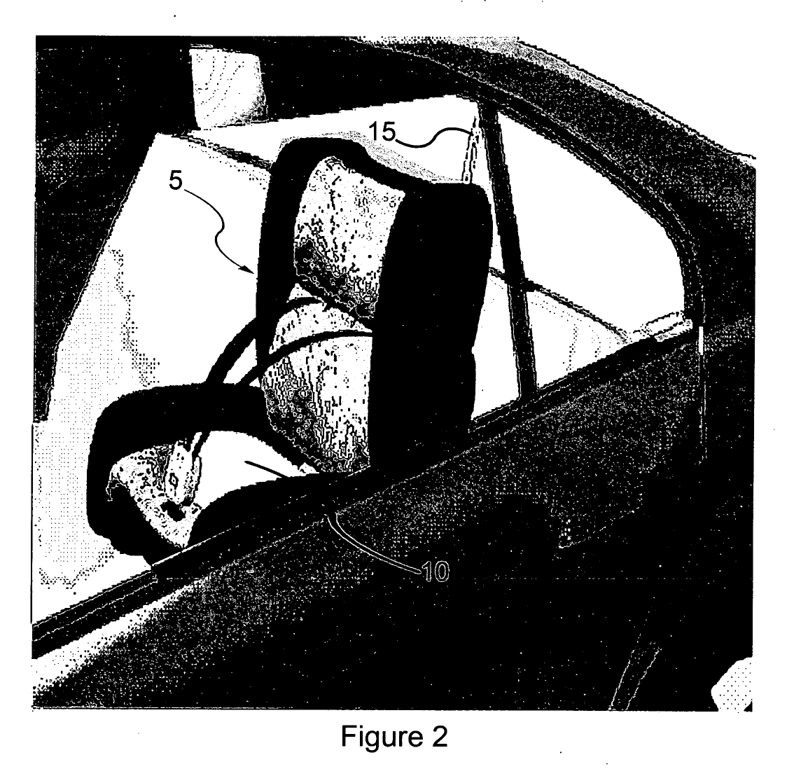

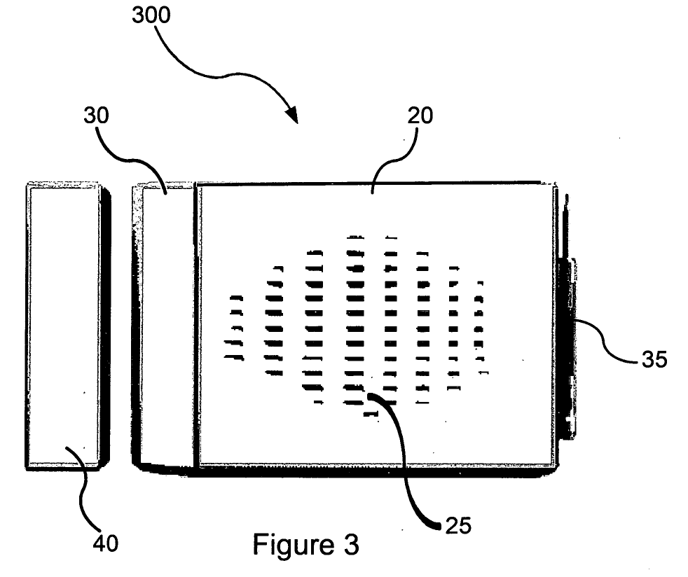

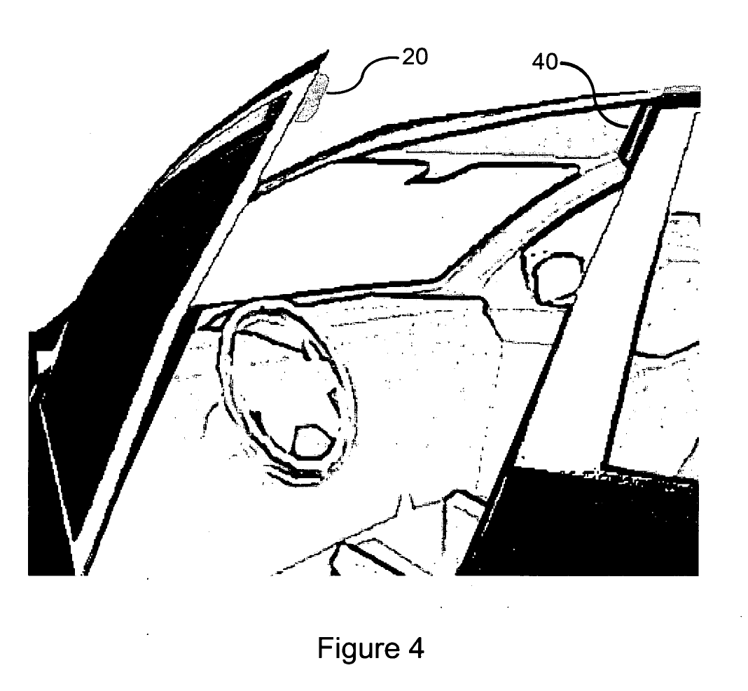

FIGS. 1 and 2 show perspective views of an exemplary child sensor device in use with an exemplary child's car seat 5, in accordance with an embodiment of the present invention. FIG. 1 shows child's car seat 5 outside of a vehicle, and FIG. 2 shows child's car seat 5 inside of a vehicle. The present embodiment comprises a weight-sensor pad 10 for inclusion inside the base area of child's car seat 5. Powered by an included battery compartment, weight sensor 10 connects to a signal-broadcasting antenna 15 by a cable. Broadcasting antenna 15 sends signals to a receiver alarm that in the present embodiment attaches to the interior frame of a driver's door, as shown by way of example in FIGS. 3 and 4.

In the present embodiment, weight-sensor pad 10 is placed directly in child's car seat 5, but in other embodiments, weight-sensor pad 10 may be placed underneath of child's car seat 5. Weight-sensor pad 10 connects by the electronic cable to broadcasting antenna 15, which can be affixed upon child's car seat 5 by a clip affixed to the exterior base of broadcasting antenna 15. In alternate embodiments broadcasting antenna 15 may be manufactured into child's car seat 5 or may be attached to child's car seat 5 by other means including, but not limited to, glue, hook and loop tape, etc. In some embodiments broadcasting antenna 15 may not include means for its attachment upon child's car seat 5, and the cable affixing broadcasting antenna 15 to the battery compartment located in weight-sensor pad 10 may be of various lengths. In some embodiments the sensor device can be made in models without an antenna, and can solely rely on wiring from weight-sensor pad 10 to broadcast the signal to the receiver to instigate the alarm.

In the preferred embodiment, weight-sensor pad 10 is a foam padding encased within a waterproof material, and measures approximately three inches in length by three inches in width by one inch in depth (3″×3″×1″). However, those skilled in the art in light of the present teachings will recognize that weight-sensor pad 10 could be made of any number of materials and in a multiplicity of alternative shapes and sizes for proper fitting upon various models of children's car seats, or in a standard size for placement underneath children's car seats. Within weight-sensor pad 10 is the accessible battery compartment for storage of two AA-sized batteries, or any other adequate number or size of batteries. This battery compartment is wired to weight-sensor pad 10. Extending from weight-sensor pad 10 is the electric cable that connects to signal-broadcasting antenna 15. In some embodiments weight sensor 10 can be set to yield activation until minimum weight forces are measured, for example, without limitation, eight pounds, so as to ensure that the alarm is generally only sounded when child's car seat 5 is occupied by a child and to avoid alarm activation due to weight sensation of the seat itself, seat cushion(s), and other mild weight items such as, but not limited to, seatbelt buckles. This minimizes the inconvenience to the user caused by false activation.

The present embodiment senses the presence of children in automobiles by weight and, if such presence is detected, generates an alert signal that is communicated to an alarm device (e.g., an audio alarm), which activates the alarm device to generate an alarm signal (e.g., loud sound) upon the opening of the driver's door. This audio alarm of the present embodiment can only be deactivated by removal of the occupant of child's car seat 5, helping to ensure that the child is not overlooked and that the vehicle operator does not fail to attend to the child immediately upon exiting the vehicle. Some embodiments of the sensor device may be configured with sensor processing electronics to algorithmically generate the alert signal based upon a usage situation that minimize false alarms; for example, without limitation, implementing a weight threshold to ignore objects placed on the seat that are too light to be a child, which are possible left on the seat.

Although the sensor and transmission units are shown as being separate, after market devices adapted to a child's seat, in alternative embodiments of the present invention, one or both may, instead, be suitable manufactured/integrated into the baby seat and/or automobile. For example, without limitation, in alternate embodiments, the weight sensor might be built directly into the rear car seat with the child seat sitting thereupon and transmission to the alarm unit, described in some detail below, may be likewise built into the car as a wired or wireless means. Furthermore, those skilled in the art, in light of the present teachings, will readily recognize a multiplicity of alternative and suitable means of communicating signals from the transmission unit to the alarm unit. By way of example, and not limitation, instead of using a radio transmitter, conventional infrared (IR) wireless communications systems may be implemented. In some embodiments (not shown), the alarm unit may be comprised with the sensor/transmitter system portion, instead of the alarm unit being separate therefrom. In such embodiments, the door opening detection means (or any other non-child occupant detection means) remotely signals the sensor/alarm unit combination, and the alarm instead broadcasts its alarm from the chair location, or possible wirelessly signals a portable communications devices as described below.

FIG. 3 shows a front view of an exemplary alarm device 300 for alerting a vehicle operator to the presence of a child in the vehicle, in accordance with an embodiment of the present invention. A base unit 20 of the alarm device comprises an audio speaker 25, a base magnetic switch 30, and a receiving antenna 35 connected to the receiver, which is also housed in base unit 20. In the present embodiment, an actuator magnet 40 is placed on the driver's side door of the vehicle in alignment with base unit 20, as shown by way of example, and not limitation, in FIG. 4. In some embodiments, base unit 20 may have a thermometer that may be set to provide readings of outdoor temperature, temperature within the automobile, or both. Although a magnetic alarm actuation device attached to the driver door is shown, any suitable actuation means as will be readily recognized by those skilled in the art may instead by implemented; e.g., without limitation, contact switches. In alternate embodiments (not shown) the door switch (e.g., base magnetic switch) may be separate from the base unit and remotely located connected to the alarm device.

The signal from broadcasting antenna 15, shown by way of example in FIGS. 1 and 2, is transmitted to the receiver, which is stored within base unit 20. In the preferred embodiment, base unit 20 is constructed of polycarbonate plastic, but in alternate embodiments other materials would be suitable such as, but not limited to other plastics. Also, base unit 20 can be made in various sizes and shapes. Within base unit 20 is a battery chamber for storage of two (2) AA-sized batteries, or any other adequate number or size of batteries, and audio speaker 25 that broadcasts through a perforated facing of base unit 20. One sidewall of base unit 20 has an open face for the exposure of base magnet 30. Actuator magnet 40 is exposed through an open face of a separate unit, and is placed in lateral alignment to base magnet 30. In the present embodiment, the unit in which actuator magnet 40 is housed is made of polycarbonate plastic and is just large enough to contain actuator magnet 40, but in other embodiments this housing unit may be made of alternate materials such as, but not limited to, other plastics, and may be any size or shape. In alternate embodiments, the receiver, the alarm device battery compartment, speaker 25, base magnet 30, and actuator magnet 40 may be contained in either housing unit, so long as base magnet 30 and actuator magnet 40 are in separate housings. Base magnet 30 maintains current contact with actuator magnet 40 while the car door is in the closed position.

FIG. 4 shows a side perspective view of an exemplary car door with an exemplary alarm device mounted to the door, in accordance with an embodiment of the present invention. The present embodiment reminds vehicle operators of the presence of a child within the vehicle when the vehicle operator first opens the door to exit the vehicle, and helps prevent vehicle operators from unintentionally leaving children in cars to be subject to, for example, the risks of temperature and a range of physical dangers. When a child occupies a car seat equipped with a sensor device according to an embodiment of the present invention, the alarm sounds from base unit 20 whenever the driver's door opens and breads the connection between actuator magnet 40 and base magnet 30, shown by way of example in FIG. 3, thus reminding the vehicle operator of the presence of a small child within the vehicle. Preferable, the alarm will continue sounding until the child is removed from the car seat.

The present embodiment activates the audio alarm immediately after the opening of the driver's-side door of the vehicle, providing the vehicle operator with a reminder of the presence of children within the vehicle. In some embodiments the alarm may broadcast a verbal message that reminds vehicle operators of the dangers the children will face when left alone in a parked car for any length of time. In alternate embodiments the alarm may make a warning sound such as, but not limited to, a buzzing sound, a ringing sound or a musical note. To help avoid being mistaken by other vehicles in the vicinity as the sounding of a car horn, the alarm preferable broadcasts in any note(s) commonly used by horns; e.g., the C note. The musical note used in the alarm tone can be produced in any pitch or combination of pitches in accordance with known techniques. The alarm may also be broadcast in various volumes through speaker 25. Some embodiments may include means for volume control such as, but not limited to, a dial or a button on base unit 20. Alternately, the alarm can broadcast various audio signals, including, but not limited to, recorded verbal commands such as “Don't forget the baby” and similar messages. The manual deactivation means of the present embodiment preferable located directly on the child'car seat, ensuring that the vehicle operator must go to the child's car seat to turn off the alarm device. However, any suitable alternate location may be implemented in other embodiments, depending upon the needs of the particular application.

In the present embodiment, actuator magnet 40 is attached to the driver's door of the vehicle, and base unit 20 is place don an interior doorframe in alignment with actuator magnet 40. In alternate embodiments actuator magnet 40 may be placed on the interior doorframe, and base unit 20 may be place don the driver's door. In the present embodiment, the placement of actuator magnet 40 and base unit 20 is accomplished by screw attachments at the proper locations. However, in alternate embodiments other attachment means may be suitable such as, but not limited to, double-sided tape or hook and loop tape.

Referring to FIGS. 1 through 4, in typical use, weight-sensor pad 10 is stored directly beneath the seating pad of child's car seat 5. The wire extending from the battery compartment in weight-sensor pad 10 extends from weight-sensor pad 10 to broadcasting antenna 15. If child's car seat 5 has occupancy, weight-sensor 10 activates broadcasting antenna 15, which begins sending signals to the receiver in base unit 20. Upon the opening of the driver's side door of the vehicle, actuator magnet 40 is removed form contact with base magnet 30. If broadcasting antenna 15 is still transmitting a signal at the time so this breach in magnet contact, indicating occupant weight in child's car seat 5, the alarm then sounds through speaker 25 of base unit 20. The vehicle operator can then turn the alarm off by removing the child from child's car seat 5, thus ceasing the transmission of the signal from broadcast antenna 15.

Those skilled in the art, in light of the present teachings, will recognize that there are many alternatives and variations for the various elements in the embodiments of the present invention described above. For example, without limitation, there may be a light display upon the exterior of base unit 20 or on the housing of actuator magnet 40 to indicate power status, to indicate low battery status, or to provide an accompanying visual display to the audio alarm. It is also contemplated that some embodiments can be made in variations as an entire child's car seat unit with a built-in weight sensor. In other embodiments, the sensing device includes wiring for attachment to the hosting vehicle's wiring system in order to detect recent disengagement of the vehicle's motor, which could trigger the alarm. It is further contemplated that in alternative embodiments, the sensing device may be configured to transmit an alarm signal to any of a multiplicity of conventional control and/or communication devices; for example, without limitation, automobile remote controls, cell phones, beepers, wrist watches, telephones (e.g., calling an emergency phone number via a cell phone in the car), and wireless digital communication protocols (e.g., WiFi, Bluetooth, 802.11, etc.).

In yet other embodiments of the present invention, the alarm device may be configured with conventional alarm processing electronics that enable the alarm unit to generate the alarm signal algorithmically based upon a usage situation that either minimize false alarms or provide a multiplicity of functionality options desired by a particular application; for example, without limitation, in some applications, it may be desirable to optionally generate the alarm signal after the door opens and closes instead of as soon as the door opens, or after keys are removed from the ignition and the door is opened/closed, etc. Some embodiments of the alarm unit may also be configured with a sound detector that may trigger the alarm signal based on detecting a sound in addition to the other alert signals described above; for example, without limitation, as a fail-safe if the sensor transmitter fails, sensing the baby crying could trigger the alarm signal.

Having fully described at least one embodiment of the present invention, other equivalent or alternative methods of implementing an in-automobile child sensor and alarm according to the present invention will be apparent to those skilled in the art. For example, those skilled in the art will readily recognize, in light of the teachings of the present invention, that a multiplicity of alternate alarm means may be implemented depending upon the needs of the particular application. By way of example, and not limitation, in alternative embodiments instead of the alarm unit being wirelessly in communication with the child's seat sensor device, wired means may be used. Or, for example, in alternative embodiments instead of detecting the opening of the driver's door with a detector, the alarm unit may instead detect the turning on/off of the automobile's dome light, possibly in conjunction with a delay timer that waits for a certain period before triggering the alarm to help ensure it was the driver that exited and not a passenger. Or, for example, in alternative embodiments instead of the sensor and alarm units being separate, after market devices, one or both may be suitable manufactured/integrated into the baby seat and/or automobile. All such alternative embodiments are contemplated as being within the scope of the present invention. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A child safety apparatus for sensing a child left alone in an automobile and alerting others thereof, the apparatus comprising:
a weight sensor unit being operable for sensing weight applied to a seat and generating a corresponding weight reading, the seat being located within the automobile and operable for the child to apply his or her weight upon when secured onto the seat;
a sensor processing unit, said sensor processing unit being configured to receive the weight reading from said weight sensor and to generate an alert signal based upon said weight sensor reading;
an alert signal transmission unit configured to receive said alert signal from said sensor processing unit and transmit said alert signal;
an occupant detection unit that is configured to detect and signal that that an occupant of the automobile has exited or intends to exit the automobile;
an alarm unit, said alarm unit being configured to receive both said transmitted alert signal from said alert transmission unit and said occupant exiting signal, said alarm unit being further configured to generate an alarm signal based on said received signal; and
an alarm communication unit, said alarm communication unit being configured to receive said alarm signal from said alarm unit, and communicate said alarm signal to a receiving person or system.

2. The automobile child safety apparatus of claim 1, in which the seat is a common child seat secured to a car seat, and said weight sensor unit is a weight-sensor pad placed onto the surface of the seat where the child sits upon.

3. The automobile child safety apparatus of claim 1, in which the seat is a common child seat secured to a car seat, and said weight sensor unit is a weight-sensor pad configured into the seat padding where the child sits upon.

4. The automobile child safety apparatus of claim 1, in which said weight reading is a binary signal indicating the presence or not of a certain amount of weight on the seat.

5. The automobile child safety apparatus of claim 1, in which said weight reading is an analog signal and said sensor processing unit comprises electronics to threshold the analog signal to thereby generate a binary alert signal that indicates the presence or not of a certain amount of weight on the seat.

6. The automobile child safety apparatus of claim 1, in which said alert signal transmission unit is a wireless transmitter system comprised of a radio transmitter and an antenna; and in which said alarm unit comprise a corresponding radio receiver configured to properly receive and decode the wirelessly transmitted alert signal.

7. The automobile child safety apparatus of claim 1, in which said alert signal transmission unit is a wireless transmitter system comprised of an infrared (IR) transmitter, and in which said alarm unit comprise a corresponding IR receiver configured to properly receive and decode the wirelessly transmitted alert signal.

8. The automobile child safety apparatus of claim 1, in which said alert signal transmission unit is a wired transmitter system, and in which said alarm unit comprise a corresponding wired receiver configured to properly receive and decode the transmitted alert signal.

9. The automobile child safety apparatus of claim 1, in which said occupant detection unit is a door opening detection switch configured to cooperate with a driver's door of the automobile to detect the opening and closing thereof, said door opening detection switch being operable to generate said signal that indicates that an operator of the automobile has exited the automobile.

10. The automobile child safety apparatus of claim 9, in which said door opening detection switch is a magnetically activated switch.

11. The automobile child safety apparatus of claim 9, in which said alarm unit only generates an alarm signal if said alert signal is activated while said door opening detection switch indicates the door has been opened and closed.

12. The automobile child safety apparatus of claim 9, in which said alarm unit comprise said door opening detection switch.

13. The automobile child safety apparatus of claim 1, in which said alarm unit is mounted to the inside of a driver'door of the automobile.

14. The automobile child safety apparatus of claim 1, in which said alarm communication unit is a audible speaker system comprised in said alarm unit, and said alarm signal is an audible alarm generated by said audible speaker system.

15. The automobile child safety apparatus of claim 1, in which said occupant detection unit is configured to cooperate with a driver's door of the automobile to detect the opening and closing thereof, said occupant detection unit further configured to generate said signal that indicates that an operator of the automobile has exited the automobile.

16. The automobile child safety apparatus of claim 15, in which said alarm unit only generates an alarm signal if said alert signal is activated while said occupant detection unit indicates the driver's door has been opened and closed.

17. The automobile child safety apparatus of claim 1, in which said alarm unit only generates an alarm signal if said alert signal is activated while said occupant exiting detection signal is activated.

18. A child safety apparatus for sensing a child left alone in an automobile and alerting others thereof, the apparatus comprising:
means for sensing weight applied to a seat and generating a corresponding weight reading, the seat being located within the automobile and operable for the child to apply his or her weight upon when secured onto the seat;
means for generating an alert signal based upon said weight sensing means;
means for receiving and retransmitting said alert signal from said alert signal generating means;
means for detecting and signaling that that an occupant of the automobile has exited or intends to exit the automobile;
means for receiving both said transmitted said signal and said occupant exiting signal; and
means for generating an alarm signal and communicating said alarm signal to a receiving person or system.
